(19) United States
(12) Patent Application Publication
(10) Pub. No.: US 2007/0288442 A1
(43) Pub. Date: Dec. 13, 2007

(54) System and a program for searching documents

(75) Inventors: Makoto Iwayama, Tokorozawa (JP); Yusuke Sato, Kokubunji (JP)

Correspondence Address: REED SMITH LLP, Suite 1400, 3110 Fairview Park Drive, Falls Church, VA, 22042, US

(73) Assignee: Hitachi, Ltd.

(21) Appl. No.: 11/806,590

(22) Filed: Jun. 1, 2007

(30) Foreign Application Priority Data
Jun. 9, 2006 (JP) 2006-161206

(51) Int. Cl. G06F 17/30

(52) U.S. Cl. 707/3

(57) ABSTRACT

A device for searching documents which expands search results and extracts highly related documents. The device has a processor, a memory for storing a program to be executed by the processor, and an input unit for input of a keyword and searches documents according to the keyword. By executing the program, it provides: a document searching module which searches documents according to the keyword; a document classifying module which classifies search results obtained by the document searching module into first sets of documents according to relations between documents; a document expansion module which searches second sets of documents, each of which are highly related to documents in the corresponding first set of documents and not included in the first set of documents; and a document displaying module which generates data to display the first sets of documents and the second sets of documents.

### CLAIM OF PRIORITY

The present application claims priority from Japanese patent application JP 2006-161206 filed on Jun. 9, 2006, the content of which is hereby incorporated by reference into this application.

### BACKGROUND OF THE INVENTION

This invention relates to technology which displays a set of documents as search results and a set of no-searched documents which are related to them.

In order to obtain all desired documents efficiently by document searching, it is necessary to narrow search results or expand search results.

A well-known method of narrowing search results is automatic classification of search results for display (refer to “Scatter/Gather: A Cluster-based approach to browsing large document collections”, Cutting, D. R., Pedersen, J. O., Tukey, J. W., ACM SIGIR-1992, pp. 318-329, 1992). Since this method collectively displays a group of documents similar in content by automatic classification of search results, the user can collect desired documents from a large volume of search results efficiently. Clustering is often used for such automatic classification.

In many clustering techniques, classification is made by regarding a document as a vector composed of words and taking the cosine between vectors as similarity between the documents. First, distances of all document pairs in a set of documents are calculated and the nearest document pair is merged. The vector of a cluster after merging is the average vector for documents in the cluster. This merging process is repeated until a specified number of clusters are obtained.

As a technique of expanding search results, relevance feedback is well known (refer to “Relevance feedback in information retrieval”, Rocchio, J. J., The SMART Retrieval System, Salton G. (Ed.), Prentice Hall, pp. 313-323, 1971). In relevance feedback, as the user selects several documents included in search results as right answers, searching is done again using keywords included in the right answer documents as new keywords or giving added weight to the keywords. Relevance feedback allows chain search of new documents related to the selected right answer documents.

### SUMMARY OF THE INVENTION

In most conventional searching methods, narrowing and expansion of search results are serially done and the display is updated upon each processing. For example, search results are automatically classified and displayed and extracted documents from the search results are expanded and the initial search results are updated by a set of documents as a result of expansion. Therefore, when document expansion cannot be done as expected, it is necessary to restore the pre-expansion search results once and re-expand the documents. This is a troublesome process and repeated expansion of the same research results may often cause the user to forget previous expansion results.

Narrowing of search results has the problem that the pairwise relatedness measure used in clustering often does not match the user's intuition. For this reason, it often happens that the resulting cluster seems less meaningful to the user and does not contribute to narrowing of search results.

Expansion of search results has the problem that it is difficult to select keywords suitable for the user's query intention according to specified documents. Selection of a wrong keyword might cause feedback to work negatively.

These subjects arise from the fact that the calculated keyword importance does not always match human intuition.

A representative aspect of this invention is as follows. That is, there is provided a device for searching documents which has a processor, a memory for storing a program to be executed by the processor, and an input unit for input of a keyword, comprising: a document searching module which searches documents based on the input keyword; a document classifying module which classifies search results obtained by the document searching module into first sets of documents based on relations between the searched documents; a document expansion module which searches a second set of documents including at least one document which is related to documents in each of the first sets of documents and is not included in the first set of documents; and a document displaying module which generates data to display the first sets of documents and the second sets of documents.

According to a preferred embodiment of this invention, in addition to a first set of documents collected by classification of keyword search results, a second set of documents consisting of highly related non-searched documents are displayed so that the user can access highly related documents other than the keyword search results.

### BRIEF DESCRIPTION OF THE DRAWINGS

The present invention can be appreciated by the description which follows in conjunction with the following figures, wherein:

FIG. 1 is a block diagram showing a configuration of a system for searching documents in accordance with an embodiment of this invention;

FIG. 2 is a flow chart showing a processing which is executed by the system for searching documents in accordance with this embodiment of this invention;

FIG. 3 is an explanatory diagram showing a display image indicating search results and expanded results in accordance with this embodiment of this invention;

FIG. 4 is an explanatory diagram showing an example of a table stored in a document DB in accordance with this embodiment of this invention;

FIG. 5A is an explanatory diagram showing an example of a table including an index for keyword search in accordance with this embodiment of this invention;

FIG. 5B is an explanatory diagram showing an example of a table including an index to collect keywords from documents in accordance with this embodiment of this invention;

FIG. 6A is an explanatory diagram showing an example of a table including an index to search a set of documents cited by a document corresponding to a document ID in accordance with this embodiment of this invention;

FIG. 6B is an explanatory diagram showing an example of table including an index to search a set of documents which cite a document corresponding to the document ID in accordance with this embodiment of this invention;

FIG. 7 is a flowchart showing a processing of document classification in accordance with this embodiment of this invention;

FIG. 8 is an explanatory diagram showing relations of a mergeable documents in accordance with this embodiment of this invention;

FIG. 9 is a flowchart showing a processing of document expansion in accordance with this embodiment of this invention;

FIG. 10 is a flowchart showing a processing of collecting citing and/or cited documents in accordance with this embodiment of this invention;

FIG. 11 is an explanatory diagram showing “depth” in accordance with this embodiment of this invention;

FIG. 12 is a flowchart showing a processing of document displaying in accordance with this embodiment of this invention;

FIG. 13 is a flowchart showing a processing of displaying a list window in accordance with this embodiment of this invention;

FIG. 14 is a flowchart showing a processing of displaying a graph window in accordance with this embodiment of this invention;

FIG. 15 is an explanatory diagram showing an example of display image of set of documents displayed adjacently in accordance with this embodiment of this invention;

FIG. 16 is an explanatory diagram showing a display image indicating search results and expanded results in a list form in accordance with this embodiment of this invention; and

FIG. 17 is an explanatory diagram showing a display image indicating search results and expanded results in a graphical form in accordance with this embodiment of this invention.

### DETAILED DESCRIPTION OF THE PREFERRED EMBODIMENTS

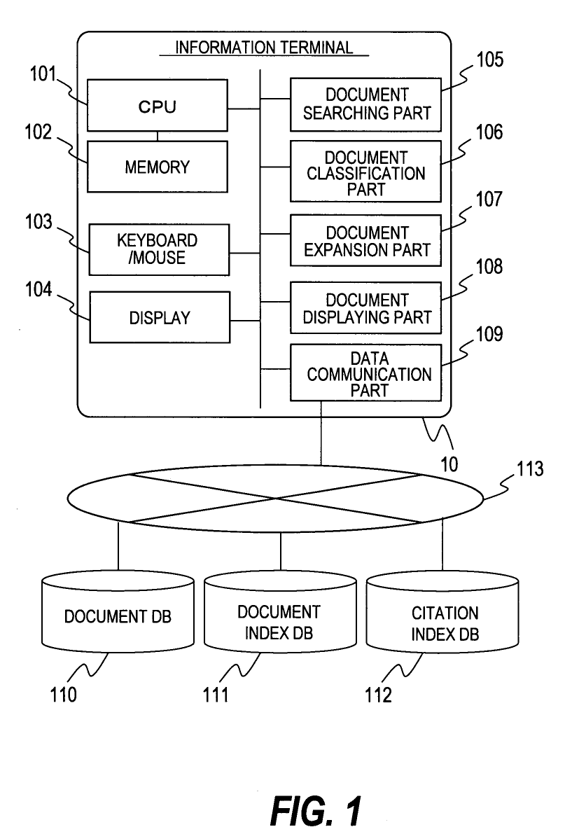

FIG. 1 shows the configuration of a system for searching documents in accordance with an embodiment of this invention. The system includes an information terminal 10, three databases (document DB 110, document index DB 111 and citation index DB 112) and a network 113. The information terminal 10 is connected with the three DBs via the network 113; instead, the three DBs may be incorporated in the information terminal 10.

The information terminal 10 includes a CPU 101, a memory 102, a keyboard and a mouse 103, a display unit 104 and a data communication part 109. The information terminal 10 stores programs which constitute a document searching part 105, a document classification part 106, a document expansion part 107, and a document displaying part 108.

The CPU 101 performs various processes by executing the various programs for the document searching part 105, document classification part 106, document expansion part 107, and document displaying part 108. The memory 102 temporarily stores a program to be executed by the CPU 101 and required data to execute the program.

The keyboard and mouse 103 are devices with which a user inputs information. The display unit 104 shows search results, etc.

The data communication part 109 is an interface for data communication via the network 113 and may be a LAN card which enables communication according to the TCP/IP protocol via local area network. The information terminal 10 communicates with the databases connected with the network 113 through the data communication part 109.

The document DB 110 stores various data related to documents.

The document index DB 111 stores relations between documents and keywords. The document index DB 111 allows the user to retrieve a list of keywords included in a document or a list of documents including a keyword.

The citation index DB 112 stores citation relations between documents. The citation index DB 112 allows the user to retrieve a list of documents cited by a certain document or a list of documents citing a certain document.

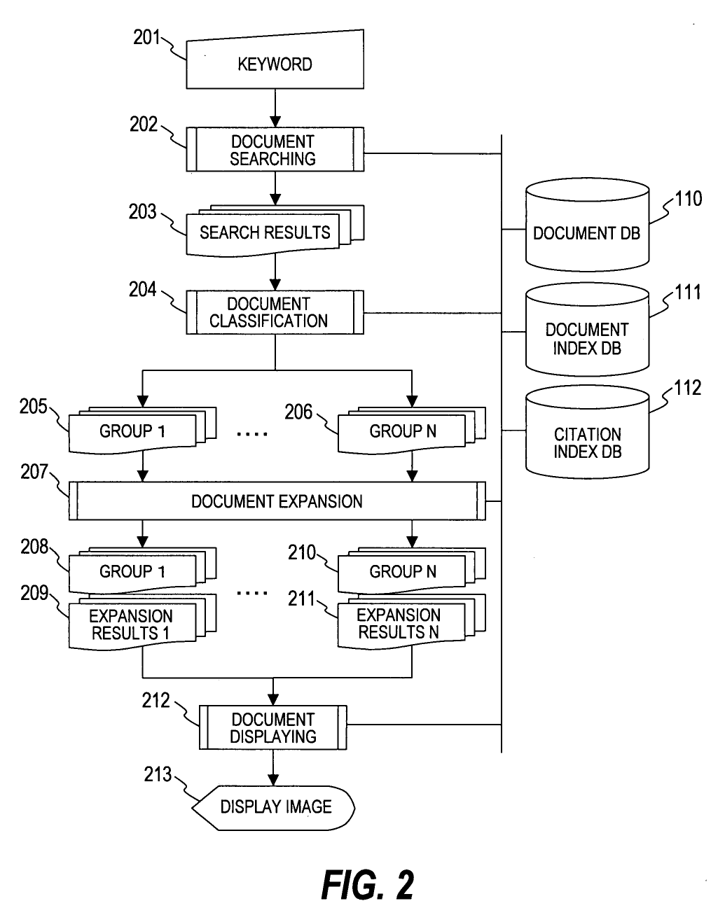

FIG. 2 shows the whole searching sequence which is performed by the system for searching documents in accordance with this embodiment of this invention. Next, referring to FIG. 2, the processes which the document searching part 105, document classification part 106, document expansion part 107, and document displaying part 108 perform will be described.

First, the user inputs a keyword 201 with the keyboard and/or mouse 103. The document searching part 105 searches the document index DB 111 for documents which include the keyword 201 and gets search results 203 (202).

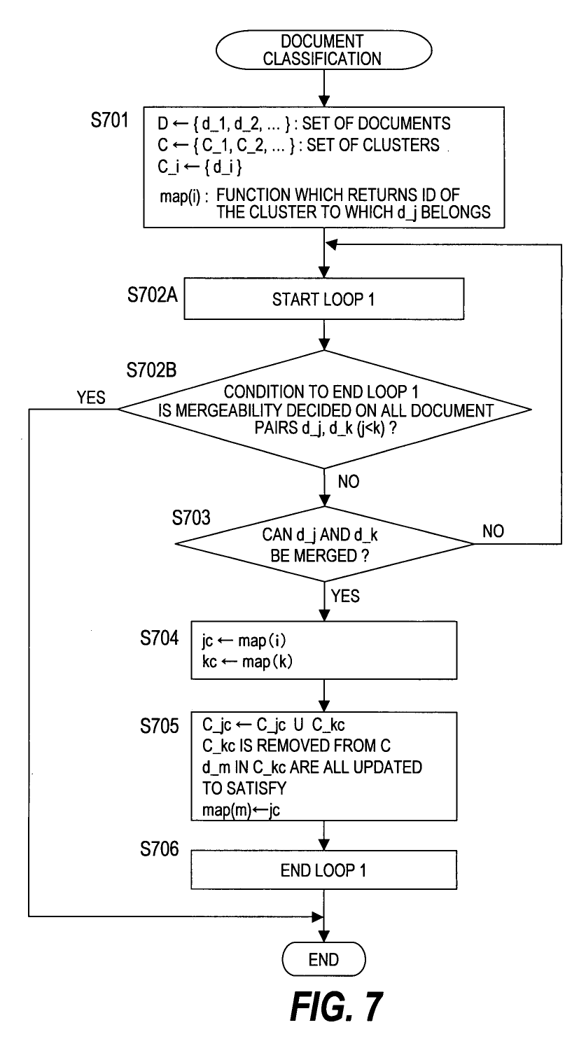

Then, the document classification part 106 refers to the citation index DB 112 to classify the search results 203 into several groups (204). In the case of FIG. 2, the search results 203 are divided into group 1 (205) to group n (206). In this embodiment of the invention, documents which have direct or indirect citation relations are classified into a group. The process will be detailed later referring to FIG. 7.

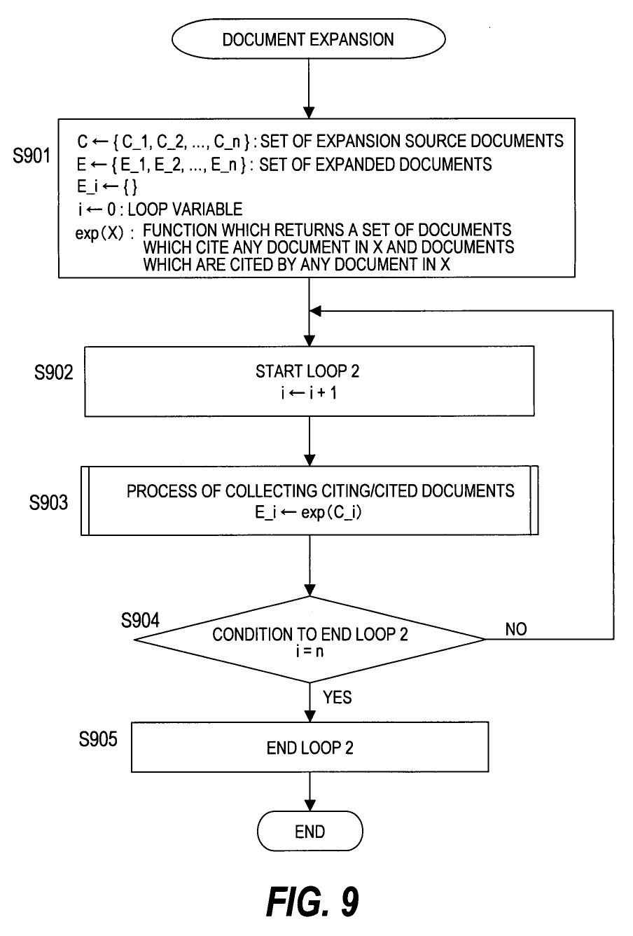

The document expansion part 107 performs document expansion on each group in reference to the citation index DB 112 (207). For example, the document expansion part 107 gets expansion results 1 (209) by searching the citation index DB 112 to extract documents other than those in group 1 which have citation relations with a document in group 1. Likewise, it performs document expansion (207) on the other groups search results. The process will be detailed later referring to FIG. 9.

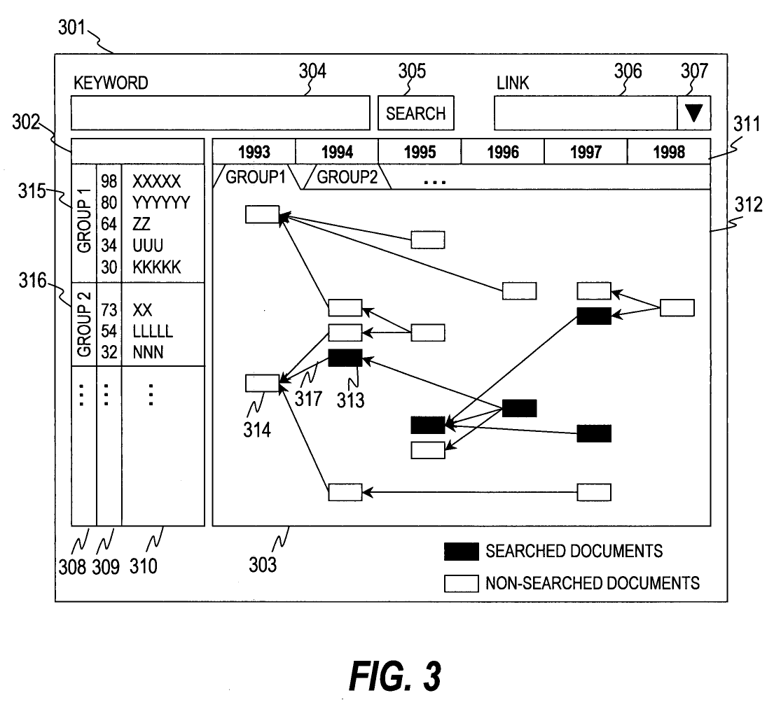

Lastly, the document displaying part 108 displays the groups and the expansion results of the groups on a display image 213 (212). A concrete display image will be described later referring to FIG. 3. In document displaying 212, reference is made to the document DB 110 and citation index DB 112 as needed.

Next, the search result display image will be described and the databases (document DB, document index DB and citation index DB) and the various processes shown in FIG. 2 (document searching 202, document classification 204, document expansion 207, document displaying 212) will be detailed.

FIG. 3 shows a search result display image 301 in the system for searching documents in accordance with this embodiment of this invention. The search result display image 301 includes a search condition input area and a search result display area. The search condition input area includes a keyword entry field 304 and a link selection field 306 and clicking a search button 305 starts searching. The search result display area includes a list window 302 and a graph window 303.

The keyword entry field 304 receives keywords which the user inputs. The link selection field 306 allows the user to select the kind of link which is shown in the graph window 303. The kind of link is the kind of citation relation between documents: if documents to be searched are patent specifications, two kinds of citations may be made: citations made by applicants in their patent specifications and those by examiners for reasons of rejection. Clicking a link select button 307 allows the user to select whether to display one kind of citation or both kinds of citations in the graph window 303. For display of plural citation relations in the graph window, links may be distinguished by color or line type.

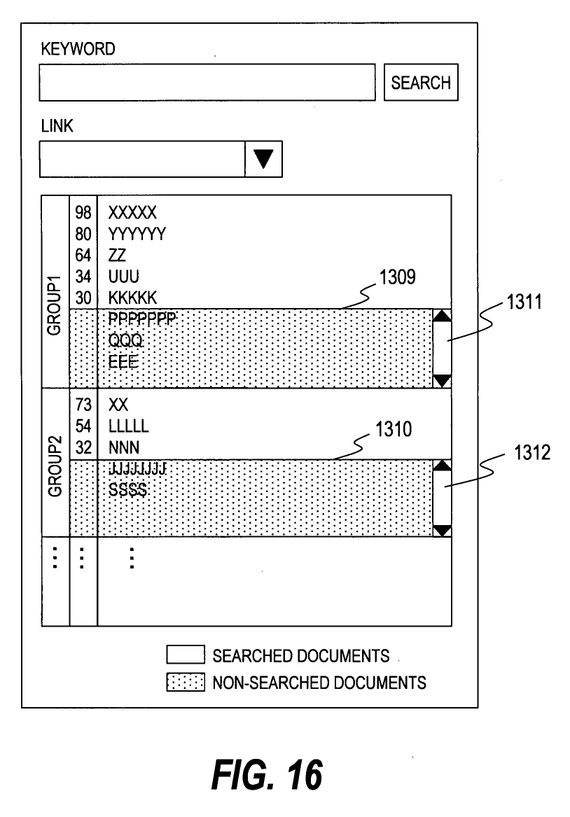

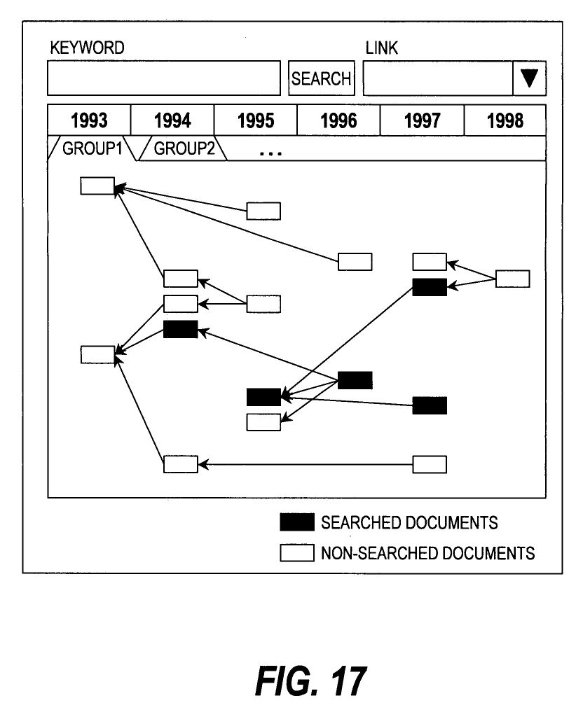

After inputting a search condition and clicking the search button 305, the searching process as shown in FIG. 2 starts. Upon completion of the searching process, the document displaying part 108 shows search results in the list window 302 group by group where the document classification part 106 has classified searched documents into groups. The result of expansion of each group is shown in the graph window 303 together with documents in the group. Although this embodiment employs two types of windows, a list window 302 and a graph window 303, it is also possible to employ one type of window. A one-window version will be described later referring to FIGS. 16 and 17.

The list window 302 shows lists of classified search results group by group. The list window 302 includes a group number field 308, a search score field 309, and a document title field 310.

In the group number field 308, group identification numbers appear: e.g. Group 1 (315), Group 2 (316) and so on as shown in FIG. 3. In the search score field 309, relevance to keyword search may appear. In the document title field 310, if searched documents are patent specifications, “title of the invention” may appear.

In the graph window 303, a graph which shows citation relations among a set of documents as search results and a set of documents collected by expansion of search results. In this embodiment, the graph window 303 shows search results group by group and switching from one group to another is made by the use of tabs. FIG. 3 shows a graph 312 which is displayed for Group 1.

Nodes in the graph (e.g. 313, 314) represent documents. A link which connects nodes (e.g. 317) expresses that the connected documents mutually have a citation relation and the direction of arrow denotes the direction of citation. A black node (e.g. 313) indicates that the document concerned is a searched document and a white node (e.g. 314) indicates that the document concerned is a non-searched document (document as an expansion result). When the document type is identified by node color like this, it is easy to distinguish between searched documents and non-searched documents related to the searched documents.

If documents to be searched are documents whose publication years are known, such as papers or patent specifications, the horizontal axis of the graph may represent year. In this embodiment, the horizontal axis 311 represents publication year. When the horizontal axis represents publication year, the arrows which represent the direction of citation (link) may be omitted because the direction of citation is automatically determined (chronological order).

Next, the databases used in various processes will be explained.

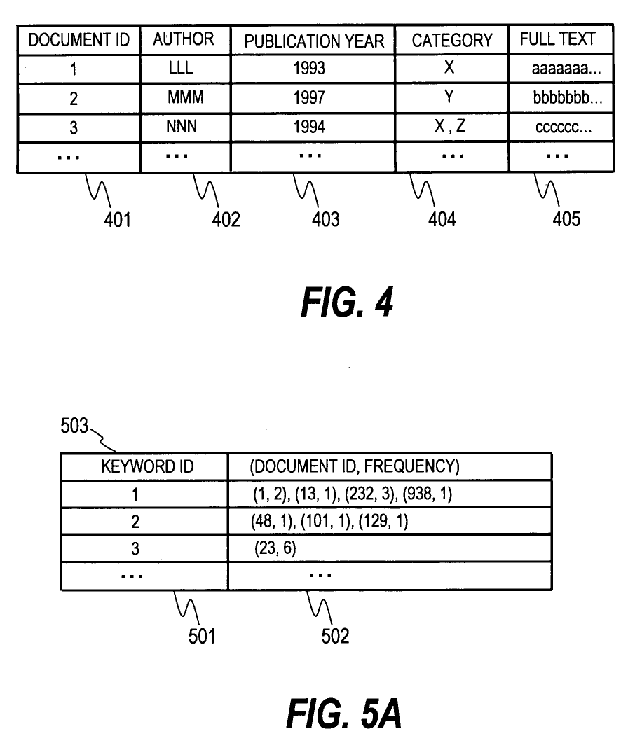

FIG. 4 shows an example of a table stored in the document DB 110 and data in accordance with this embodiment of this invention. The table which includes document data includes the following columns: document ID 401, author 402 and publication year 403, category 404, and full text 405.

The document ID 401 is a number which uniquely identifies a stored document. The author 402 denotes the author of the document. The publication year 403 denotes the year when the document was published. The category 404 is the category (e.g. the IPC) to which the document belongs. The table shown here is just one example. What columns (factors) should be defined depends on the type of document. The full text 405 is a column in which the full text of the document is stored.

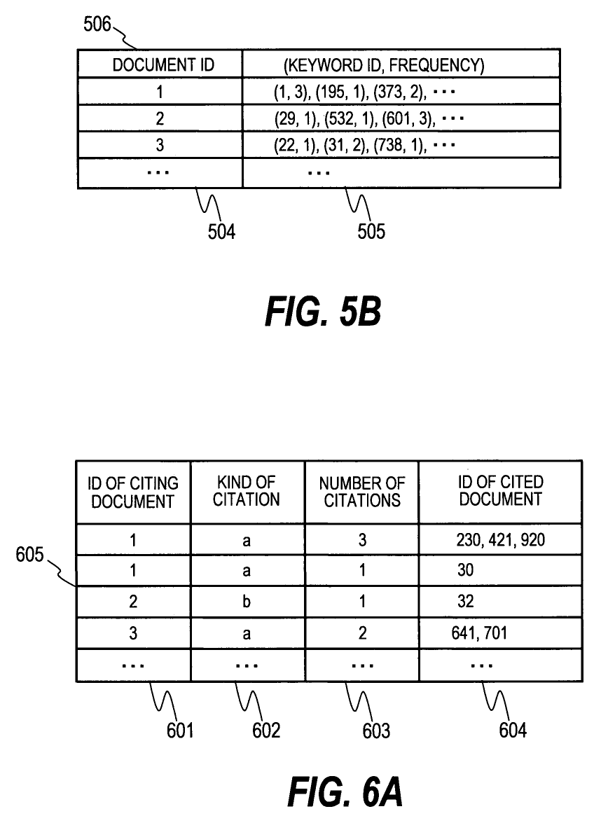

FIG. 5A and FIG. 5B show examples of tables stored in the document index DB 111 in accordance with this embodiment of this invention. The document index DB 111 stores two types of index 503 and 506.

FIG. 5A shows a table which includes an index 503 for keyword search in this embodiment. The index 503 includes keyword IDs 501 and document ID-frequency pairs 502 (list). The document ID 501 identifies a document including the keyword concerned and Frequency expresses the number of appearances of the keyword in the document. The index 503 is used for searching by keyword. Frequency is used to calculate the score of a searched document and rank search results. Further information on calculations for ranking of search results is given, for example, in “Modern Information Retrieval”, Ricardo Baeza-Yates et al., Addison Weisley, pp.27-30, 1999.

FIG. 5B shows a table which includes an index 506 to collect keywords from documents in this embodiment. The index 506 includes a pair list of document ID 504 and keyword ID-frequency 505. The keyword ID identifies a keyword which the document concerned includes and frequency expresses the number of appearances of the keyword in the document. The index 506 is used to calculate similarity between documents according to the degree of keyword overlap. Further information on calculations of similarity between documents is also given in the above publication about information search algorithm.

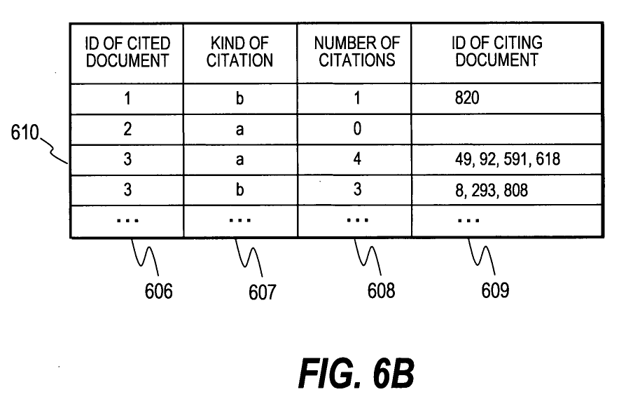

FIG. 6A and FIG. 6B show examples of tables stored in the citation index DB 112 in accordance with this embodiment of this invention. The citation index DB 112 stores two types of index 605 and 606.

FIG. 6A shows a table which includes an index 605 to search a set of documents cited by a document corresponding to a document ID in this embodiment. The index 605 includes ID of citing document 601, kind of citation 602, number of citations 603, and ID of cited document 604 (list). The kind of citation 602 represents the kind of citation relation as mentioned above. When information on a cited document is given in a document like a patent specification in which the applicant gives information on documents cited therein as mentioned above, the cited document can be identified by character string search. Since patent specifications use a prescribed form to describe cited patent documents (e.g. Japanese Patent Application Publication No. 2006-123456), the cited documents can be easily identified by character string search. On the other hand, there are cases that citations are stored in databases, like citations by patent examiners.

FIG. 6B shows a table which includes an index 610 to search a set of documents which cite a document corresponding to a document ID in this embodiment. The index 610 includes ID of cited document 606, kind of citation 607, number of citations 608 and ID of citing document 609.

Next, the processes of document searching 202, document classification 204, document expansion 207, and document displaying 212 in this embodiment will be detailed.

The document searching part 105 performs the process of document searching 202 using a known document searching method. For example, it uses the index 503 to search documents which include a specified keyword. When more than one keyword are specified, logical computation such as logic operation “AND” or logic operation “OR” between sets of documents searched by the keywords is done.

FIG. 7 is a flowchart showing the processing sequence of document classification 204 in accordance with this embodiment of this invention. The document classification part 106 performs document classification 204. In the process of document classification 204, a set of searched documents are classified into clusters. In this embodiment, clustering is done so that documents which have direct or indirect citation relations belong to a cluster.

As the process of document classification 204 starts, the document classification part 106 first makes initialization (S701). D(={d_1, d_2, . . . , d_n}) represents a set of documents to be classified and C(={C_1, C_2, . . . , C_n}) represents a set of clusters. The set of clusters C in its initial state is a set of singleton clusters, each of which, say C_i, includes the document d_i as a element, and is expressed by C_i={d_i}. Function map represents a function which returns ID of the cluster to which a document belongs. In the initial state, the function for document d_i is map(i)=i.

Upon completion of initialization, the document classification part 106 performs Loop 1 on all document pairs that satisfy j<k(d_j, d_k). Here Loop 1 is steps from S702 to S706. At the step of S702B, whether the condition to end Loop 1 is met is decided.

The document classification part 106 decides whether d_j and d_k can be merged (S703). In this embodiment, if there is a citation relation between documents, the paired documents are decided to be mergeable.

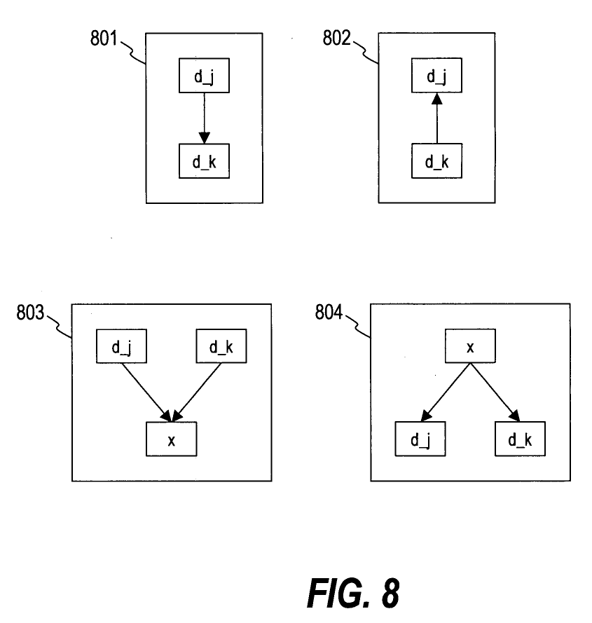

FIG. 8 shows relations of the mergeable documents in accordance with this embodiment of this invention. The figure indicates that a document at the root of an arrow cites a document pointed by the arrow.

Citations 801 and 802 represent direct citation relations where either d_j or d_k cites the other. Citation 803 represents a co-citation relation where d_j and d_k cite a common document x. Citation 804 represents bibliographic coupling where d_j and d_k are cited by a common document x. Whether a citation relation is a direct citation, bibliographic coupling or co-citation is easily investigated by referring to the indices 605 and 610 of the citation index DB 112. In this embodiment, when d_j and d_k have a direct relation, bibliographic coupling or co-citation relation, they are decided to be mergeable. However, other criteria for mergeability (for example, combination of the three types of citation relation) may also be used.

Looking back at the flowchart in FIG. 7, the subsequent steps are explained below.

If paired documents (d_j, d_k) are mergeable (the answer at S703 is “Yes”), the document classification part 106 updates the set of clusters C so that the documents d_j, d_k belong to the same cluster. If they are not mergeable (the answer at S703 is “No”), the document classification part 106 determines the mergeability of another document pair.

If paired documents (d_j, d_k) are mergeable, the document classification part 106 first obtains cluster ID jc of the cluster to which document d_j belongs, using the map function (S704). Similarly it obtains cluster ID kc of the cluster to which document d_k belongs (S704). Specifically this leads to jc=map(d_j), kc=map(d_k).

Then, the document classification part 106 merges the clusters which include the documents d_j and d_k and updates the map function (S705). In this embodiment, a cluster with a larger ID number is merged into a cluster with a smaller ID number. Hence, cluster C_kc is merged into cluster C_jc and cluster C_jc is the union of cluster C_jc and cluster C_kc (C_jc=C_jc U C_kc). Furthermore, it removes C_kc from the whole set of clusters C. Also it updates the map function so that the relation map(m)=jc holds for all the documents d_m included in C_kc and changes the cluster to which they belong from C_kc to C_jc.

Upon completion of the step S705, the document classification part 106 finishes the merging process for the document pair (d_j, d_k) and returns to 702A to determine the mergeability of another document pair.

After the mergeability of all document pairs has been determined and the condition to end Loop 1 is satisfied (the answer at S702A is “Yes”), the document classification part 106 ends Loop 1 to finish the process of document classification 204. This creates a set of clusters C where documents which can be merged belong to a cluster. The clusters included in the set C correspond to Group 1 (205) to Group n (206) as shown in FIG. 2.

FIG. 9 is a flowchart showing the processing sequence of document expansion 207 in accordance with this embodiment of this invention. The document expansion part 107 performs document expansion 207. In the process of document expansion 207, clusters as classified by document classification 204 are expanded to create sets of expanded documents. In this embodiment, documents belonging to each cluster are expanded according to citation relation. Hence, in expanding a document x, if it has a direct or indirect citation relation with another document y, the document y will become an expanded document of the document x. However, tracing citations unlimitedly would lead to a huge number of expanded documents. Hence the number of expanded documents should be limited. The concrete steps are explained below.

As the process of document expansion 207 starts, the document expansion part 107 first makes initialization (S901). C(={C_1, C_2, . . . , C_n}) represents a set of documents to be expanded which is a set of clusters created by document classification 204. E(={E_1, E_2, . . . , E_n}) represents a set of expanded documents. The elements of the set of expanded documents E are a set of documents E_i corresponding to cluster C_i in C, which is an empty set in its initial state. Variable i is a loop variable which controls Loop 2, which is zero in its initial state. Function exp(X) is a function which, upon input of a set of documents X, returns a set of documents which cite any document in X or which are cited by any document in X.

Upon completion of initialization, the document expansion part 107 performs document expansion 207 on the set of expansion source documents C. At the step of S902, 1 is added to loop variable i.

The document expansion part 107 collects a set of documents citing any document in the set of documents C_i or documents being cited by any document in C_i, using the function exp (X) (S903).

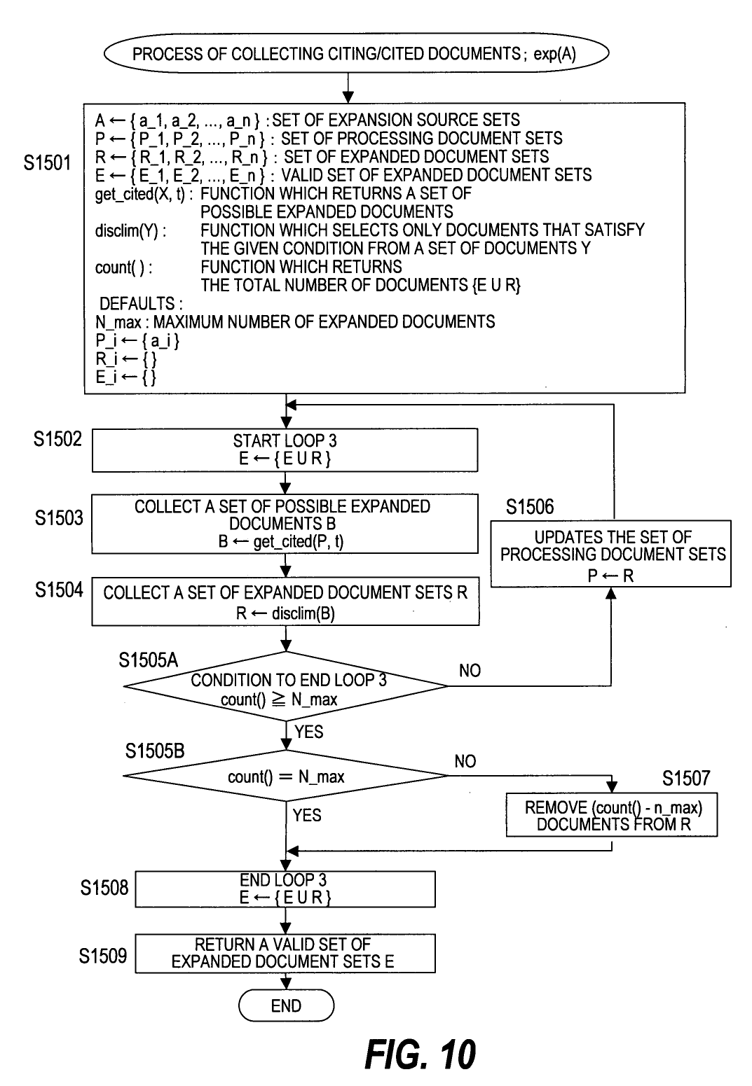

FIG. 10 is a flowchart showing the process of collecting citing or cited documents using the function exp (X) in accordance with this embodiment of this invention.

As the process for the function exp (X) is started, first initialization is made. A(={a_1, a_2, . . . , a_n}) represents a set of expansion source sets as a set of documents to be expanded. P(={P_1, P_2, . . . , P_n}) represents a set of processing document sets which include transitional documents which are being expanded in the course of document expansion. R(={R_1, R_2, . . . , R_n}) represents a set of expanded document sets collected by a single expansion loop process which will be described later. E(={E_1, E_2, E_n}) represents a set of expanded documents finally collected by the process of collecting citing or cited documents. The document expansion part 107 sets defaults as follows: P_i={a_i}; R_i={ }; and E_i={ } (S1501). Here the sets of documents P, R, and E are sets of document sets which correspond to element sets P_i, R_i, and E_i respectively. N_max represents the maximum number of documents included in the valid set of expanded document sets E. The maximum number of expanded documents N_max may be either a predetermined value or a user-defined value.

Function get-cited (X,t) is a function which, upon input of a set of documents X(={X_1, X_2, . . . , X_n}) and kind of citation t, collects a set of documents citing the set of documents X_i or being cited by X_i and returns a set of possible expanded documents Y(={Y_1, Y_2, . . . , Y_n}). Function disclim (Y) is a function which, upon input of a set of documents Y(={Y_1, Y_2, . . . , Y_n}), selects only documents that satisfy the given condition for expanded documents (stated later) from the documents included in Y_i to create a set of documents Z_i and outputs a final set of expanded document sets Z(={Z_1, Z_2, . . . , Z_n}). Function count ( ) is a function which returns the total number of documents in the union of E and R.

Upon completion of initialization, the document expansion part 107 starts Loop 3. The document expansion part 107 adds the set-of expanded document sets R to the valid set of expanded document sets E (S1502). Specifically, it calculates the union of sets of documents E_i and R_i included in E and R respectively (E_i U R_i) and regards it as a new valid set of expanded document sets E.

Then, upon input of a set of processing document sets P and kind of citation t, the document expansion part 107 collects a set of possible expanded documents B(={B_1, B_2, . . . , B_n}) using the function get_cited (P, t) (S1503). Typical methods of collecting possible expanded documents are: breadth-first search in which documents to be expanded are searched from documents in a brotherly relation and depth-first search in which they are searched from documents in a parent-child relation. Several other methods are available and detailed information is well known. In this embodiment, possible expanded documents are documents which directly cite processing documents to be expanded, or documents which are directly cited by processing documents. The process of collecting citing or cited documents uses the citation index DB112. The kind of citation t may be user-defined as shown in FIG. 3 (search screen) or predetermined.

Upon input of the set of possible expanded documents collected at step S1503, the document expansion part 107 collects a set of expanded document sets R which satisfy the given condition for expanded documents using the function disclim (B) (S1504). In this embodiment, the condition for expanded documents includes four requirements: document z (1) should not overlap document a_i included in the set of expansion source sets A; (2) should not overlap document e_i included in the valid set of expanded document sets E; (3) should have a depth from the document a_i in the set of expansion source sets which is less than maximum depth Dp_max; and (4) should have a high importance. The function disclim ( ) selects only documents that satisfy all these four requirements. For example, “importance” of a document in the fourth requirement is determined according to the number of times the document has been cited and if its importance exceeds a preset importance level, it is decided to have a high importance.

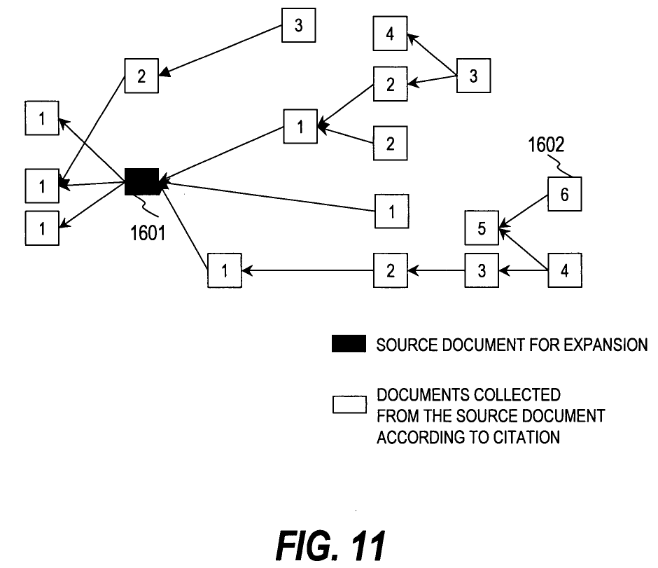

FIG. 11 illustrates the length of citation chain in the third requirement in accordance with this embodiment of this invention. In the figure, a rectangle represents a document and arrows suggest that a document at the root of an arrow cites a document pointed by the arrow. The number inside each rectangle expresses “depth” of the document from document 1601 as an expansion source. Here, the depth of document 1602 is 6 and if the maximum depth Dp_max is 3, the document 1602 is decided not to satisfy the third requirement. The maximum depth Dp_max may be predetermined or user-defined.

Looking back at the flowchart in FIG. 10, the subsequent steps are explained below.

Upon collection of the set of expanded document sets R, the document expansion part 107 calculates the number of elements of the union of sets (E U R) obtained by adding the set of expanded document sets R to the set of collected document sets E using the function count ( ) and decides whether it is larger than the maximum number of expanded documents N_max (S1505A) or not. If it is smaller than the maximum number of expanded documents N_max (the answer at S1505A is “No”), the document expansion part 107 updates the set of processing document sets P to the set of expanded document sets R (S1506) and returns to S1502 and repeats the steps of Loop 3.

Alternatively it is also possible to arrange that even if the result of count ( ) is below N_max, Loop 3 is ended when a given number of steps in Loop 3 has been carried out.

If the result of count ( ) is N_max or more (the answer at S1505A is “Yes”), the document expansion part 107 decides whether the result of count ( ) is equal to the maximum number of expanded documents N_max (S1505B).

If the result of count ( ) is larger N_max (the answer at S1505B is “No”), excess documents are removed from the set of expanded document sets R (S1507). Specifically, (count( )−N_max) documents are removed from the set of expanded document sets R in ascending order of importance. The importance of a document may be determined according to the number of times the document has been cited, as mentioned above.

If the answer at S1505B is “Yes”, or when the step S1507 has been finished, the document expansion part 107 takes the union of sets E and R ({E U R}) as the final set of expanded documents E (S1508).

Lastly the document expansion part 107 returns the set of expanded documents E as the return value of the function exp(X) and ends the process of collecting citing or cited documents (S1509).

Looking back at the flowchart in FIG. 9, the subsequent steps are explained below.

Upon completion of step S903, the document expansion part 107 decides whether the condition to end Loop 2 is satisfied (S904). If loop variable i is below the number of elements n of the set of expansion source documents (the answer at S904 is “No”), it returns to S902. If loop variable i is equal to the number of elements n in the set of expansion source documents (the answer at S904 is “Yes”), it ends Loop 2 and finishes the process of document expansion 207.

When the document expansion process has been done on all groups, a set of documents as an expansion result is obtained for each group. The sets of documents thus obtained as expansion results correspond to expansion result 1 (209) through expansion result n (210) in FIG. 2.

Next, the process of document displaying 212 displays groups as search results, and results of expansion of the groups, on the display image 213. FIG. 3 illustrates an example of display image in this embodiment.

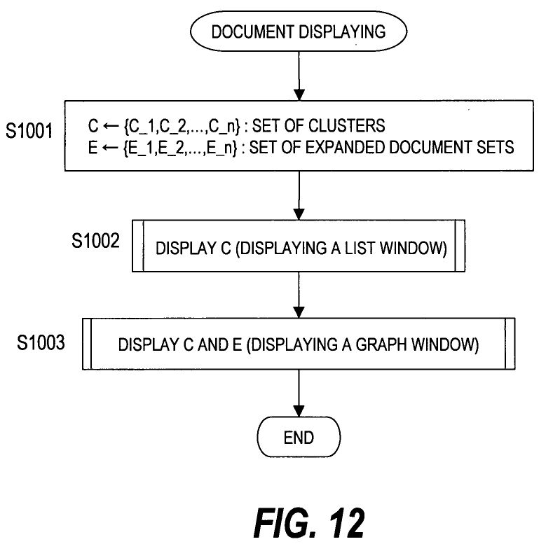

FIG. 12 is a flowchart showing the processing sequence of document displaying 212 in accordance with this embodiment of this invention. The document displaying part 108 performs document displaying 212. The process of document displaying 212 is explained below referring to FIG. 3.

As the process of document displaying 212 starts, the document displaying part 108 first makes initialization (S1001). C(={C_1, C_2, . . . , C_n}) represents a set of clusters as classified search results and E(={E_1, E_2, . . . , E_n}) represents a set of expanded document sets as collected by document expansion 207. E_i is a set of documents as obtained by expansion of the corresponding C_i.

Upon completion of initialization, the document displaying part 108 displays the list window 302 as shown in FIG. 3 (S1002). Upon completion of displaying the list window 302, it displays the graph window 302 as shown in FIG. 3 (S1003). The process of displaying the list window 302 and the graph window 303 will be detailed later.

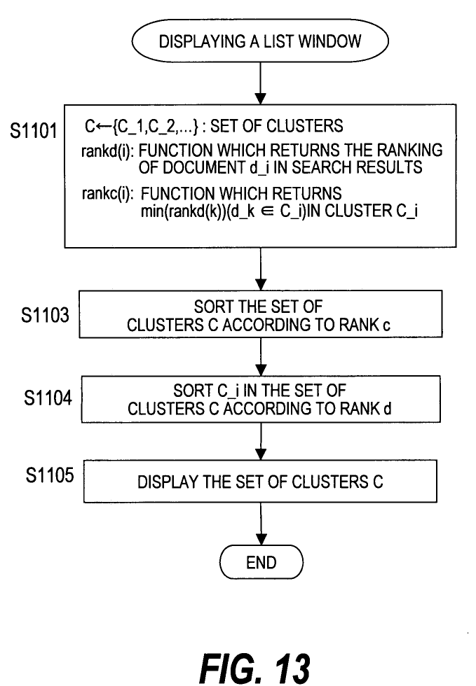

FIG. 13 is a flowchart showing the sequence of displaying the list window 302 in accordance with this embodiment of this invention.

As displaying of the list window 302 starts, the document displaying part 108 makes initialization (S1101). C(={C_1, C_2, . . . , C_n})represents a set of documents as classified search results. When a document number is input, function rankd returns the ranking of the document in search results. When cluster number i is entered, the function rankc returns the highest ranking in search results among documents in cluster C_i. The highest ranking among documents in a cluster is regarded as the ranking of that cluster.

Then the document displaying part 108 sorts the set of clusters C according to cluster ranking (S1103). Further, the documents in cluster C_i are sorted according to the ranking of documents in each cluster C_i (S1104).

Lastly, the document displaying part 108 displays clusters in the list window 302 in descending order of cluster ranking. It displays documents in each cluster in descending order of document ranking (S1105).

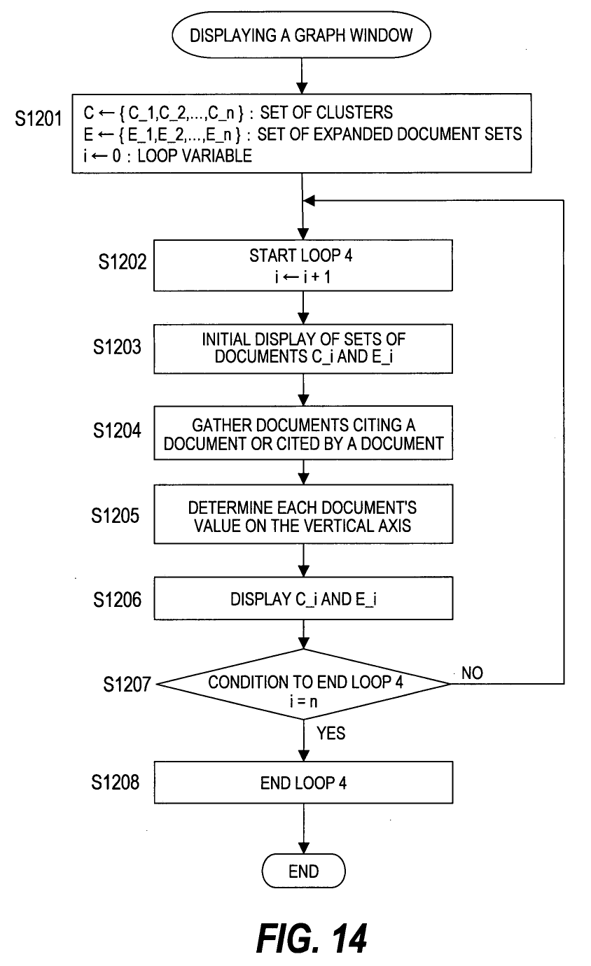

FIG. 14 is a flowchart showing the sequence of displaying the graph window 303 in accordance with this embodiment of this invention.

As the process of displaying the graph window 303 starts, the document displaying part 108 makes initialization (S1201). C(={C_1, C_2, . . . , C_n}) represents a set of clusters as classified search results and E(={E_1, E_2, . . . , E_n}) represents a set of expanded document sets as collected by document expansion 207. E_i an element of E, is a set of documents as obtained by expansion of the corresponding C_i. Variable i is a loop variable which controls Loop 4 and its initial value is 0.

Upon completion of initialization, the document displaying part 108 starts the process of displaying for each set of documents. At step S1202, number i increases one by one until loop variable i reaches the number of elements in the set of clusters C.

The document displaying part 108 makes an initial display of nodes representing the documents in C_i and E_i (S1203). In this embodiment, the horizontal axis of the graph window 303 expresses document publication year and nodes are arranged according to document publication year. A node may be positioned anywhere on the vertical axis as far as it is within the horizontal axis's region corresponding to the publication year of the document concerned. The publication year of each document can be obtained by reference to the document DB 110.

Then, the document displaying part 108 updates the positions of documents on the vertical axis so that documents citing a common document or cited by a common document are gathered and adjacent to each other (S1204). The subsequent steps are explained referring to FIG. 5A and FIG. 5B.

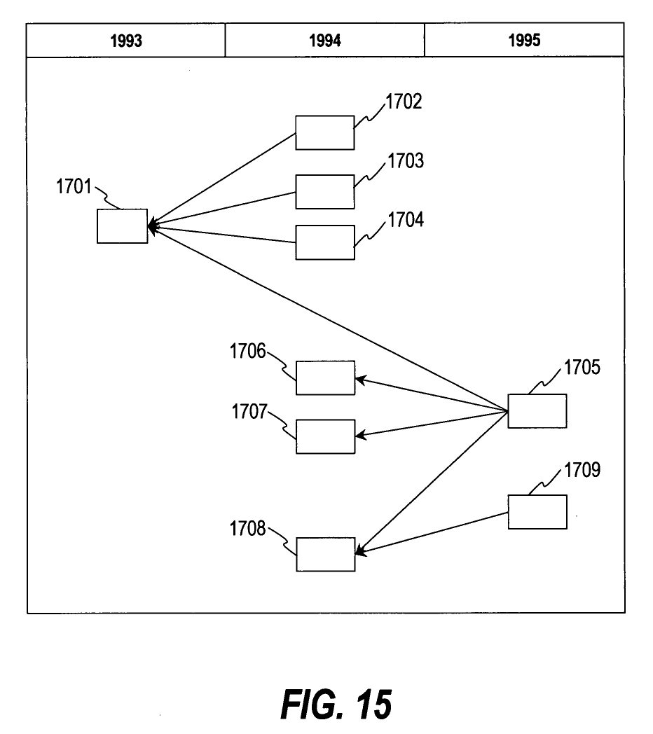

FIG. 15 illustrates an example of arrangement of nodes in the graph window 303 in accordance with this embodiment of this invention where nodes representing documents mutually having citation relations are adjacent to each other. Since documents 1702, 1703, and 1704 cite a common document 1701, they are adjacent to each other. On the other hand, document 1705 cites document 1701 but it is different in publication year from the above three documents; therefore the node of document 1705 cannot be positioned within the same region of the horizontal axis as the nodes of the three documents. Hence, the node is slightly away from the three nodes in the vertical direction so that the arrows indicating citations do not cross.

Since documents 1706, 1707, and 1708 are cited by a common document 1705, they are adjacent to each other. However, since document 1708 is also cited by another document 1709, there is a possibility that document 1708 cannot be adjacent to documents 1706 and 1707. At step S1204 it is unnecessary to ensure that arrows indicating citations do not cross and at step S1205 the positions of nodes on the vertical axis are finally determined.

The document displaying part 108 determines the final value (node position) on the vertical axis (S1205). This embodiment employs a known method which takes into consideration the positional center of gravity of a set of cited/citing documents. Various methods of determining positional data on documents mutually having citation relations are available, as discussed in “How to Draw a Directed Graph”, Eades, P. et al (Journal of Information Processing, 13, pp. 424-437, 1990).

The document displaying part 108 arranges documents in sets of documents C_i and E_i according to positional data as determined at steps S1204 and S1205 and adds arrows which indicate citations to make a display (S1206). The document displaying part 108 uses different colors so that it is easy to visually discriminate between documents in the set of clusters C and those in the set of expanded document sets E. Also, different colors may be used for documents according to author or category in reference to the data stored in the document DB 111. Moreover, the nodes for the documents in the set of clusters C may be different in shape from those for the documents in the set of expanded document sets E to facilitate discrimination between them.

Lastly, the document displaying part 108 decides whether the condition to end Loop 4 is satisfied (S1207). Specifically, if loop variable i is below the number of elements n in the set of clusters (the answer at S1207 is “No”), it returns to S1202. If loop variable i is equal to the number of elements n in the set of clusters (the answer at S1207 is “Yes”), it ends Loop 4 and finishes the process of displaying the graph window 303 for documents.

With the procedure explained above, the document displaying part 108 displays the list window 302 and the graph window 303. Although the above embodiment uses a double-window structure as shown in FIG. 3 to display search results and expansion results, these results may be displayed in one window. Next, an explanation will be given of a variation of the above embodiment in which search results are displayed in one window.

FIG. 16 shows that search results and expansion results are displayed simultaneously in a list window in accordance with this embodiment of this invention. The list window in FIG. 16 is structurally the same as that in FIG. 3 except that the list of documents of each group is followed by results of expansion of the group. Specifically results of expansion of group 1 are shown in area 1309 and those of group 2 are shown in area 1310. Scrollbars 1311 and 1312 are used to scroll the expansion result display areas.

FIG. 17 shows that search results and expansion results are displayed simultaneously in a graph window in accordance with the above embodiment of this invention. As compared with FIG. 3, the list window 302 is omitted.

While classification and expansion of documents are done on the basis of citations in the above embodiment, an embodiment of the invention in which classification and expansion are done on the basis of similarity between documents is also possible. Similarity between documents can be determined using the method called the vector space model (refer to “Modem Information Retrieval”, Ricardo Baeza-Yates et al., Addison Weisley, 1999) in which the degree of overlap of keywords in documents is used as a measure for calculation.

Specifically, in order to calculate similarity between two documents d_i and d_j, the index 506 which includes document IDs, and keyword ID-frequency relations as shown in FIG. 5B are used. Then vectors v_i and v_j whose elements are keywords in the documents are generated. The value of each element of each vector corresponds to the frequency of appearance of the corresponding keyword in the corresponding document and the frequency of appearance can be obtained from the index 506. Also the so-called TF-IDF method may be used for weighting. Further information on the TF-IDF method is given, for example, in “Modem Information Retrieval.” Vector angle cos(vi, vj) is regarded as the distance between two documents i and j.

Some methods of clustering documents on the basis of similarity between documents are well known. In the method called bottom-up clustering, first minimum clusters, each of which includes only one document are generated and the nearest cluster pairs are merged sequentially. Here the vector of a cluster is the average of vectors of documents in the cluster.

One approach to expanding documents on the basis of document similarity is to re-search documents which are similar to documents in clusters as expansion sources. This is done, for example, by extracting a set of keywords which all documents in an expansion source cluster include and searching documents which include these keywords. In searching documents by keywords, the index 503 which includes keyword IDs and document ID-frequency relations is used. This kind of searching technique is well known and its detailed description is omitted here. If too many keywords are involved, weighting should be done to use only higher-ranking keywords. The abovementioned TF-IDF method may be used for weighting.

In an embodiment in which classification and expansion are done on the basis of similarity, it is impossible to generate only one link between documents and; therefore, for display in the graph window, a process to generate a link only between documents the similarity of which exceeds a given threshold is necessary. Search results and expansion results may be displayed simultaneously in the list window as shown in FIG. 16.

According to the preferred embodiments of this invention, since a citation relation between documents has a definite meaning, clustering on the basis of citation has a definite meaning that documents in a cluster mutually have direct or indirect citation relations. Clustering on the basis of citation may be easier for the user to understand than the conventional clustering method based on the degree of word overlap, enabling search results to be narrowed or expanded effectively.

According to the preferred embodiments of this invention, citation relations among documents in a cluster are graphically displayed so that the user can visually grasp the relations among the documents and retrieve a desired document from the documents in the cluster more easily.

While the present invention has been described in detail and pictorially in the accompanying drawings, the present invention is not limited to such detail but covers various obvious modifications and equivalent arrangements, which fall within the purview of the appended claims.

What is claimed is:

1. A device for searching documents which has a processor, a memory for storing a program to be executed by the processor, and an input unit for input of a keyword, comprising:
a document searching module which searches documents based on the input keyword;
a document classifying module which classifies search results obtained by the document searching module into first sets of documents based on relations between the searched documents;
a document expansion module which searches a second set of documents including at least one document which is related to documents in each of the first sets of documents and is not included in the first set of documents; and
a document displaying module which generates data to display the first sets of documents and the second sets of documents.

2. The device for searching documents according to claim 1, wherein the document classifying module calculates the relation between the documents based on a citation relation between documents to classify search results.

3. The device for searching documents according to claim 2, wherein the document displaying module generates data to display the first sets of documents and the second sets of documents in a form of a graph in which citation relations between documents included in the first sets of documents and documents included in the second sets of documents are expressed by links which connect them.

4. The device for searching documents according to claim 3, wherein the document displaying module generates data to display documents citing the same document being adjacent to each other and documents cited by the same document being adjacent to each other.

5. The device for searching documents according to claim 2, wherein the document expansion module decides whether to include a document into one of the second sets of documents based on at least one of the length of citation chain and importance of the document.

6. The device for searching documents according to claim 1, wherein the document classifying module calculates relation between documents based on the degree of overlap in character string distributions of documents.

7. The device for searching documents according to claim 1, wherein the document displaying module generates data to display a display area for the first sets of documents and a display area for the second sets of documents separately.

8. The device for searching documents according to claim 1, wherein the document searching module calculates scores of documents included in the search results in relation to the keyword; and
wherein the document displaying module
calculates a score of each of the first sets of documents based on the scores of documents included in the first set of documents;
generates data to display the first sets of documents in order of the scores of the first sets of documents; and
generates data to display the documents included in each of the first sets of documents in order of the scores of the documents.

9. The device for searching documents according to claim 1, wherein the document displaying module generates data to display distinguishably the documents included in the first sets of documents and the documents included in the second sets of documents.

10. A machine-readable medium storing a document searching program, containing at least one sequence of instructions that, when executed, causes a computer to search documents from a database holding documents based on an input keyword,
the program causing the computer to:
receive input of the keyword;
search documents from the database storing documents based on the input keyword;
classify the search results into first sets of documents based on relations between the searched documents;
search a second set of documents which is related to each of the first sets of documents and is not included in the first set of documents; and
display the first sets of documents and the second sets of documents.

11. The machine-readable medium, containing at least one sequence of instructions according to claim 10, wherein,
in the classification process, the relation between the documents is calculated based on a citation relation between documents.

12. The machine-readable medium, containing at least one sequence of instructions according to claim 11, wherein,
in the displaying process, the first sets of documents and the second sets of documents are displayed in a form of a graph in which citation relations between documents included in the first sets of documents and documents included in the second sets of documents are expressed by links which connect them.

13. The machine-readable medium, containing at least one sequence of instructions according to claim 12, wherein,
in the displaying process, documents citing the same document are displayed adjacently to each other and documents cited by a document are displayed adjacently to each other.

14. The machine-readable medium, containing at least one sequence of instructions according to claim 11, wherein,
in the displaying process, whether to include a document into one of the second sets of documents is decided based on at least one of the length of citation chain and importance of the document

15. The machine-readable medium, containing at least one sequence of instructions according to claim 10, wherein, in the classifying process, relation between documents is calculated based on the degree of overlap in character string distributions of documents.

16. The machine-readable medium, containing at least one sequence of instructions according to claim 10, wherein,
in the displaying process, a display area for the first sets of documents and a display area for the second sets of documents are displayed separately.

17. The machine-readable medium, containing at least one sequence of instructions according to claim 10,
wherein in the searching process, scores of documents included in the search results are calculated in relation to the keyword; and
wherein in the displaying process,
a score of each of the first sets of documents is calculated based on the scores of documents included in the first set of documents;
data to display the first sets of documents are generated in order of the scores of the first sets of documents; and
data to display the documents included in each of the first sets of documents are generated in order of the scores of the documents.

18. The machine-readable medium, containing at least one sequence of instructions according to claim 10, wherein,
in the displaying process, data to display distinguishably the documents included in the first sets of documents and the documents included in the second sets of documents are generated.
